(19) United States
(12) Patent Application Publication
(10) Pub. No.: US 2015/0172677 A1
(43) Pub. Date: Jun. 18, 2015

(54) Restricted Intra Deblocking Filtering For Video Coding

(71) Applicant: TELEFONAKTIEBOLAGET L M ERICSSON (PUBL), Stockholm (SE)

(72) Inventor: Andrey Norkin, Solna (SE)

(21) Appl. No.: 14/412,825

(22) PCT Filed: May 16, 2013
(86) PCT No.: PCT/SE2013/050557

§ 371 Date: Jan. 5, 2015

Related U.S. Application Data
(60) Provisional application No. 61/668,539, filed on Jul. 6, 2012.

(51) Int. Cl. H04N 19/159; H04N 19/52; H04N 19/82; H04N 19/117; H04N 19/176; H04N 19/86

(52) U.S. Cl. CPC H04N 19/159; H04N 19/176; H04N 19/86; H04N 19/82; H04N 19/117; H04N 19/52

(57) ABSTRACT

A filtering control involves checking a block size of an intra-predicted block (4, 5, 7) of pixels of a picture (2) in a video sequence (1). The block size is compared to a specified threshold. It is then determined, based on the comparison of the block size to the specified threshold, whether to apply filtering to top-most and/or left-most pixels in the intra-predicted block (4, 5, 7) of pixels. The embodiments thereby improve the subjective quality of intra-prediction, while still keeping the objective gains brought by filtering.

### TECHNICAL FIELD

The present embodiments generally relate to encoding and decoding of pictures in a video sequence, and in particular to filtering control for intra predicted blocks in such pictures.

### BACKGROUND

Intra-frame or intra-picture prediction is used in a video coding standard in order to improve the efficiency of coding without reference to other video frames or pictures. Intra prediction is applied to blocks that are located in the first picture in a video sequence or in a random access point. It can also be applied to blocks that are located in inter-predicted video pictures in case it is not possible to find a good match for the block in one of the reconstructed pictures used for prediction. The intra prediction of the block is done from the already reconstructed pixels that belong to the same picture.

Intra prediction in High Efficiency Video Coding (HEVC) uses pixel values of pixels located next to a block that is being predicted. These neighboring pixel values are used to predict the samples in the block, also referred to as prediction unit (PU). Prediction unit is a rectangular block which is used as a basic block for prediction. The total number of available prediction modes is dependent on the size of the corresponding PU, as shown in Table 1 below.

TABLE 1
number of available prediction modes

| PU size | Number of Intra prediction modes |
|---|---|
| 4 | 17 |
| 8 | 35 |
| 16 | 35 |
| 32 | 35 |
| 64 | 35 |

There are several types of intra prediction modes. In a directional intra prediction, the pixel values of the neighboring pixels are copied into the predicted block along the specified direction. If the directional intra prediction does not result in a sample position that corresponds to an exact position of one of the neighboring pixels, an interpolated value between two neighboring pixel values is used instead. The intra prediction coding provides up to 35 prediction modes including DC and planar modes for the luma component of each PU.

FIG. 12 illustrates the available intra prediction modes and FIG. 13 illustrates the 33 possible intra prediction directions. For PU sizes where less than the full set of 35 total intra prediction modes is allowed, the first N directions, according to the mapping between the intra prediction direction and the intra prediction mode number specified in FIG. 14, are used.

There are also two special prediction modes, a DC prediction mode and a planar prediction mode. In the DC prediction mode, samples in the block are assigned a value, which is equal to the average pixel value of the neighboring samples along the vertical and horizontal block boundary.

In order to improve prediction in certain modes, for example in the vertical and horizontal directional prediction and in the DC mode, a special type of processing, i.e. filtering, is applied to the top-most and/or left-most pixels in the block.

In the DC prediction mode filtering is applied to the top-most and left-most pixels or border samples in the block, whereas in the vertical prediction mode and the horizontal prediction mode the left-most pixels and the right-most pixels or border samples, respectively, are filtered.

Although filtering of the top-most and left-most samples of the predicted block brings improvement in compression efficiency, it may result in subjective quality artifacts. FIGS. 15A to 15C exemplify the problem with filtering an intra-predicted block in the DC prediction mode. FIG. 15A illustrates a blocking artifact in a Riverbed sequence with intra prediction turned on. DC intra filtering and intra filtering for the vertical and horizontal modes may introduce singularities along the block boundary. These singularities may still remain after adding the reconstructed residual as shown in FIG. 15B. The artifacts remain visible even after deblocking filtering has been applied as shown in FIG. 15C.

Hence, there are rooms for improvement in connection with intra prediction of blocks of pixels in pictures of a video sequence.

### SUMMARY

It is a general objective to provide an improved filtering control of intra-predicted block of pixels.

It is a particular objective to improve subjective quality of intra prediction.

These and other objectives are met by embodiments disclosed herein.

An aspect of the embodiments relates to a filtering control method. The method comprises checking a block size of an intra-predicted block of pictures in a video sequence. The block size is compared to a specified threshold. The method also comprises determining whether to apply filtering of top-most and/or left-most pixels in the intra-predicted block of pixels based on the comparison of the block size to the specified threshold.

Another aspect of the embodiments relates to a filtering control device comprising a processing unit configured to check a block size of an intra-predicted block of pixels of a picture in a video sequence. The processing unit is also configured to compare the block size to a specified threshold. A determining unit of the filtering control device is configured to determine whether to apply filtering of top-most and/or left-most pixels in the intra-predicted block of pixels based on the comparison of the block size to the specified threshold.

Further aspects of the embodiments relate to an encoder comprising a filtering control device as defined above and a decoder comprising a filtering control device as defined above. An additional aspect of the embodiments defines a user equipment comprising an encoder according to above and/or a decoder according to above. Yet another aspect of the embodiments relates to a network device being or belonging to a network node in a communication network. The network device comprises an encoder according to above and/or a decoder according to above.

A further aspect of the embodiments relates to a computer program for filtering control. The computer program comprises code means which when executed by a processing unit causes the processing unit to check a block size of an intra-predicted block of pixels of a picture in a video sequence. The code means also causes the processing unit to compare the block size to a specified threshold and determine whether to apply filtering of top-most and/or left-most pixels in the intra-predicted block of pixels based on the comparison of the block size to the specified threshold.

A related aspect of the embodiments defines a computer program product comprising computer readable code means and a computer program according to above stored on the computer readable code means.

Yet another aspect defines a media terminal comprising a processing unit and a memory. The memory comprises code means executable by the processing unit. The media terminal is operative to check a block size of an intra-predicted block of pixels of a picture in a video sequence. The media terminal is also operative to compare the block size to a specified threshold and determine whether to apply filtering of top-most and/or left-most pixels in the intra-predicted block of pixels based on the comparison of the block size to the specified threshold.

The embodiments provide a restricted intra filtering to thereby improve the subjective quality of intra-prediction, while still keeping the objective gains brought by filtering.

### BRIEF DESCRIPTION OF THE DRAWINGS

The embodiments, together with further objects and advantages thereof, may best be understood by making reference to the following description taken together with the accompanying drawings, in which:

FIG. 1A is a flow diagram illustrating a filtering control method according to an embodiment;

FIG. 1B is a flow diagram illustrating a method performed in a transmitter according to an embodiment;

FIG. 1C is a flow diagram illustrating a method performed in a receiver according to an embodiment;

FIG. 2 is a schematic block diagram of an encoder according to an embodiment;

FIG. 3 is a schematic block diagram of a decoder according to an embodiment;

FIG. 4 is a schematic block diagram of a user equipment according to an embodiment;

FIG. 5 is a schematic block diagram of a user equipment according to another embodiment;

FIG. 6 is a schematic block diagram of a network device according to an embodiment;

FIG. 7 is a schematic block diagram of a filtering control device according to an embodiment;

FIG. 8 is a schematic block diagram of a computer according to an embodiment;

FIG. 9 is a flow diagram illustrating an embodiment of steps in the filtering control method in FIG. 18;

FIG. 10 is a flow diagram illustrating another embodiment of steps in the filtering control method in FIG. 18;

FIG. 11 is a flow diagram illustrating a further embodiment of steps in the filtering control method in FIG. 18;

FIG. 12 is a diagram illustrating available intra prediction modes;

FIG. 13 is a diagram illustrating available intra prediction directions;

FIG. 14 is a diagram illustrating mapping between intra prediction directions and intra prediction mode numbers;

FIGS. 15A-15C illustrate problems with visible artifacts for an intra-predicted block in DC prediction mode after intra-filtering (FIG. 15A), after adding reconstructed residual (FIG. 15B) and after applying deblocking filtering (FIG. 15C);

FIG. 16 is a schematic overview of a video sequence of pictures;

FIG. 17 illustrates an example of a coding tree unit hierarchically split in a quad-tree structure of coding units and prediction units;

FIG. 18 is a flow diagram illustrating a filtering control method according to another embodiment; and

FIG. 19 is a flow diagram of additional, optional steps of the filtering control method of FIG. 18.

### DETAILED DESCRIPTION

Throughout the drawings, the same reference numbers are used for similar or corresponding elements.

The present embodiments generally relate to encoding and decoding of pictures in a video sequence, and in particular to filtering control for intra predicted blocks in such pictures.

FIG. 18 is a flow diagram illustrating a filtering control method according to an embodiment. The method generally starts in step S1, which comprises checking a block size of an intra-predicted block of pixels of a picture in a video sequence.

Each intra-predicted block of pixels has a respective size in terms of number of pixels that the intra-predicted block encompasses in the picture. The block size is generally defined as nS×nT pixels, but is typically quadratic, i.e. nS×nS pixels. In such a case, the block size could be defined as the number of pixels encompassed by the intra-predicted block, i.e. nS×nS (or more generally nS×nT), by the height or width of the intra-predicted block, i.e. nS for a quadratic block, or by a parameter derived from the height or width of the intra-predicted block, e.g. log 2(nS).

A next step S2 comprises comparing the block size to a specified threshold. It is then determined, in step S3, whether to apply filtering of top-most and/or left-most pixels in the intra-predicted block of pixels based on the comparison of the block size to the specified threshold.

Thus, the filtering control method provides a conditional or restricted filtering of the top-most and/or left-most pixels in the intra-predicted block of pixels. This means that only intra-predicted blocks of pixels that have block size that meets a predefined criterion dictated by the specified threshold will be exposed to filtering of the top-most and/or left-most pixels. If the predefined criterion is not met no filtering of the top-most and/or left-most pixels will be applied to the intra-predicted block of pixels.

Filtering of top-most and/or left-most pixels in intra-predicted blocks of pixels is generally referred to as boundary value smoothing in the art. See, for instance, section IV. HEVC Video Coding Techniques, G. Intrapicture Prediction, 5) Boundary Value Smoothing, in IEEE Transactions on Circuits and Systems for Video Technology, vol. 22, no. 12, December 2012, pages 1649-1668. This boundary value smoothing is traditionally employed to remove discontinuities along block boundaries in special intra prediction modes.

An intra-predicted block of pixels can be regarded as consisting of a number of rows of pixels and a number of columns of pixels, such as nS rows and nS columns for a block size of nS×nS pixels. The top-most pixels in an intra-predicted block of pixels then constitute the pixels present in the first or uppermost row of pixels. The left-most pixels correspondingly constitute the pixels present in the first or left-most column of pixels in the intra-predicted block of pixels.

The pixels in an intra-predicted block of pixels are generally numbered from pixel p[0,0] or p[0][0] in the upper left corner to pixel p[nS−1, nS−1] or p[nS−1][nS−1] in the lower right corner. In such a case, the top-most pixels consist of pixels p[x,0] or p[x][0] with x=0 . . . nS−1 and the left-most pixels consist of pixels p[0, y] or p[0][y] with y=0 . . . nS−1.

In a particular embodiment, the filtering control method comprises, see FIG. 19, applying, in step S4, filtering of the top-most and/or the left most pixels in the intra-predicted block of pixels if the block size is smaller than (or smaller than or equal to) the specified threshold. Correspondingly, the filtering control method comprises preventing, in step S5, applying filtering of the top-most and/or the left-most pixels in the intra-predicted block of pixels if the block size is larger (not smaller) than (or larger than or equal to) the specified threshold.

Thus, in this particular embodiment filtering of the top-most and/or the left-most pixels is restricted to intra-predicted block of pixels with smaller sizes, i.e. having a block size smaller than the specified threshold. Larger intra-predicted blocks of pixels will then not have any applied filtering of the top-most and/or left-most pixels.

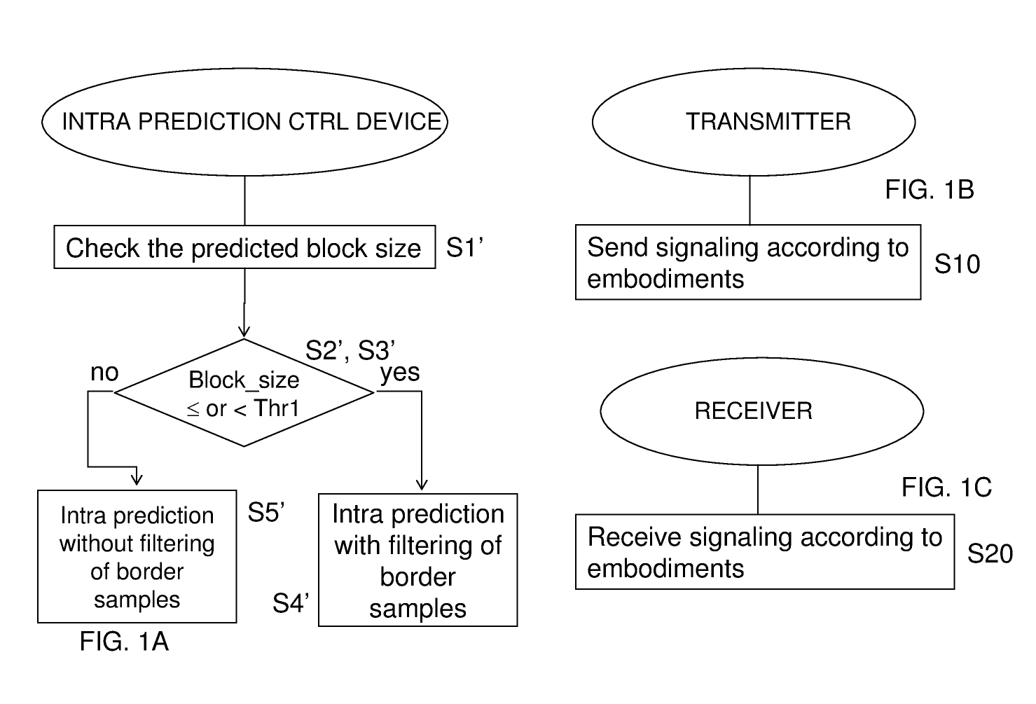

FIG. 1A is a particular implementation example of the method illustrated in FIG. 18. Steps S1′ checks the block size referred to as predicted block size (block_size) in FIG. 1A. The following steps S2′, S3′ implement the comparing and determining steps of FIG. 18. Accordingly, in this implementation example, the block size is compared to the specified threshold (Thr1). In a first embodiment, if the block size is smaller than the specified threshold it is determined to apply filtering of top-most and/or left-most pixels in the intra-predicted block. Hence, intra prediction as performed in step S4′ involves filtering of these so-called border samples of the block. In a second embodiment, such filtering is applied in step S4′ if the block size is equal to or smaller than the specified threshold.

However, if the block size is, in the first embodiment, equal to or larger than the specified threshold or, in the second embodiment, larger than the specified threshold, then the method continues to step S5′ where application of filtering to the top-most and/or left-most pixels in the intra-predicted block is prevented. Hence, intra prediction in step S5′ is performed without any filtering of these so-called border samples of the block.

As is well known in the art, pixels of a picture generally have a respective pixel value, typically representing a color of the pixel. Various color formats are available including luminance (luma) and chrominance (chroma). In such a case, a pixel could comprise a respective luma component and two respective chrominance components. In a particular embodiment, the filtering of the top-most and/or left-most pixels is restricted to filtering luma components.

Hence, in an embodiment step S3 of FIG. 18 comprises determining, for luma components of the pixels, whether to apply filtering of top-most and/or left most pixels in the intra-predicted block of pixels based on the comparison of the block size to the specified threshold.

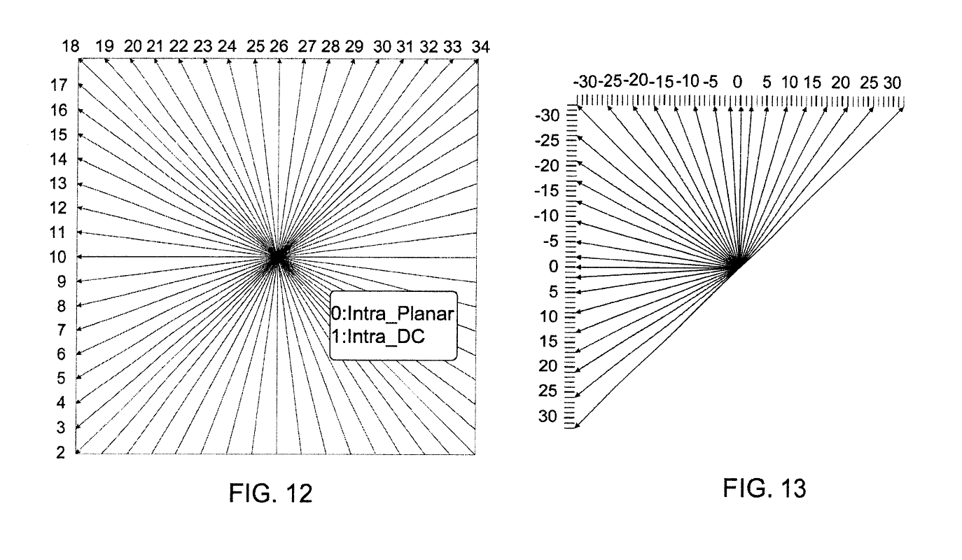

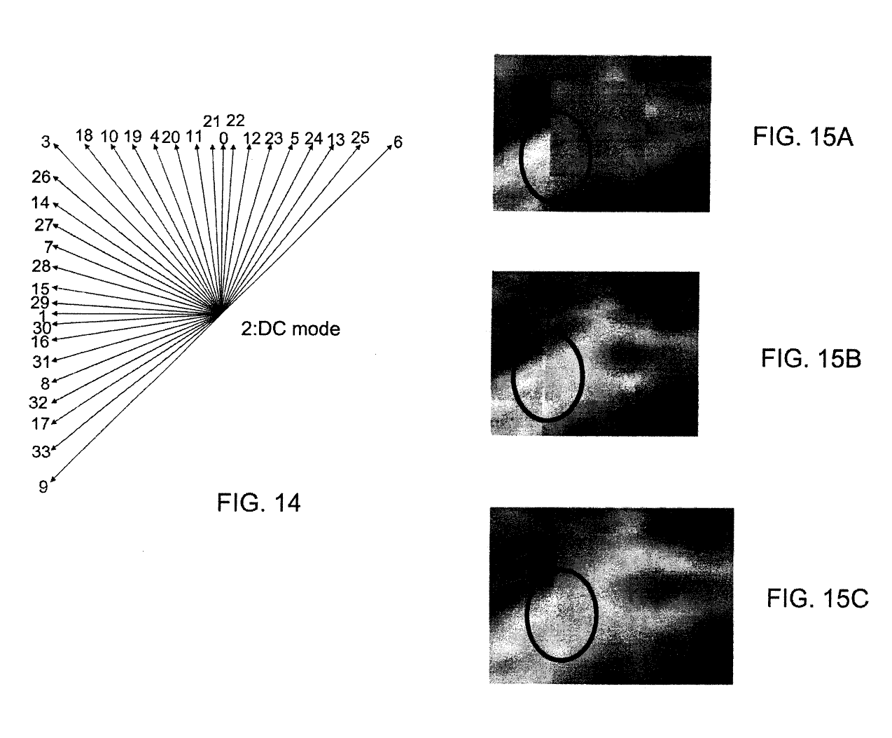

The boundary value smoothing is traditionally used in three intra prediction modes: the DC mode, i.e. intra prediction mode number 1, see FIG. 12; horizontal prediction mode, i.e. intra prediction mode number 10 or Intra_Angular[k] with k=10; and vertical prediction mode, i.e. intra prediction mode number 26 or Intra_Angular[k] with k=26.

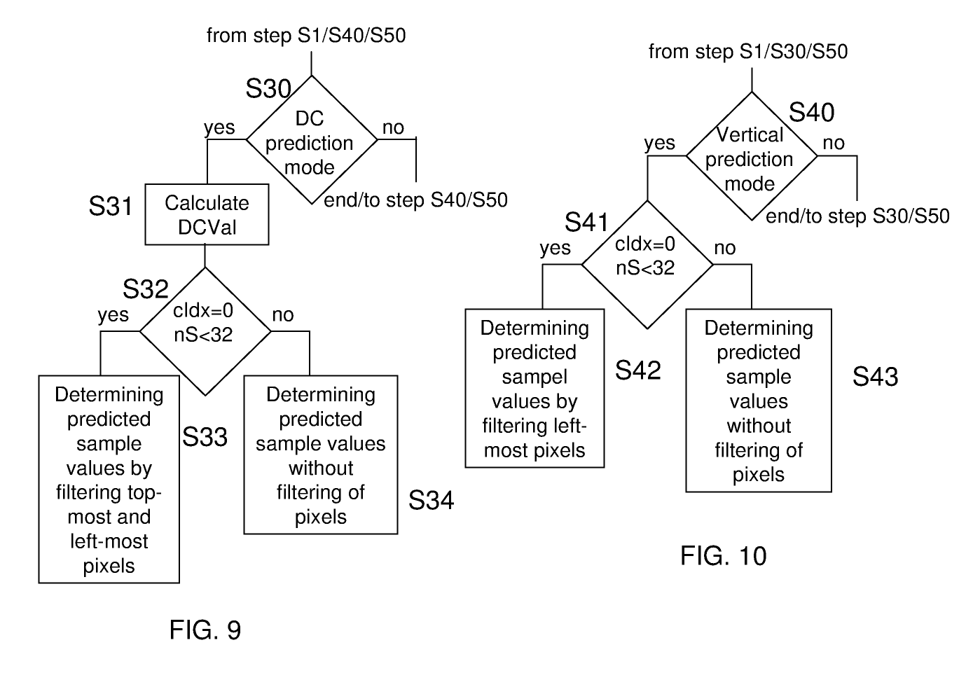

In an embodiment the filtering control method further comprises determining, in step S30 of FIG. 9, that the intra-predicted block of pixels is intra-predicted according to the DC prediction mode. In such a case, step S3 of FIG. 18 preferably comprises determining whether to apply filtering of the top-most and the left-most pixels in the DC intra-predicted block of pixels based on the comparison of the block size to the specified threshold.

Thus, it is proposed in this embodiment to apply filtering, such as averaging with neighboring/reference samples, of the top-most and left-most pixels or samples in the DC prediction mode in the intra-predicted block only for the blocks of the smaller size. Therefore, before applying the filtering to the top-most and left-most samples of the intra-predicted block, a check for the block size should be done. The filtering is applied only if the block size is below a specified threshold. Otherwise, filtering is not applied.

It is proposed to restrict application of the filtering of the border pixels or samples to the block, the size of which is smaller than 16×16 pixels or samples. Alternatively, it is proposed to restrict the application of the filtering of the border pixels or samples to a block having a block size that is smaller than 32×32 pixels or samples.

FIG. 9 is a flow diagram illustrating an embodiment of steps S2-S3 in FIG. 18 and steps S4-S5 in FIG. 19 for an intra-predicted block of pixels having DC mode (Intra_DC) as intra prediction mode.

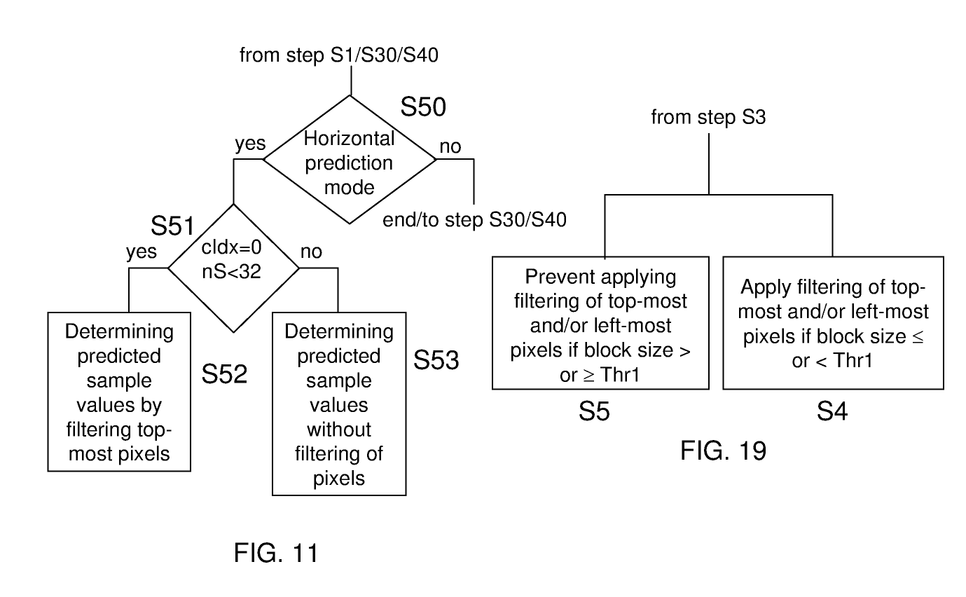

The method continues from step S1 of FIG. 18 or from steps S40 or S50 in FIG. 10 or 11 to be further described herein. A first step S30 comprises, which has already been discussed in the foregoing, determining that the intra-predicted block of pixels is intra-predicted according to the DC prediction mode. This step S30 can be performed based on the intra-prediction mode number or identifier assigned to or determined for the intra-predicted block of pixels.

If it is not predicted according to the DC prediction mode the method ends or continues to steps S40 or S50 in FIG. 10 or 11. If the intra-predicted block of pixels is predicted according to the DC prediction mode the method continues to step S31, which comprises calculating a variable DCVal.

This variable DCVal is preferably calculated as:

$$DCVal = ( {\sum }_{{x}^{′} = 0}^{nS - 1} p [ {x}^{′} , - 1 ] + {\sum }_{{y}^{′} = 0}^{nS - 1} p [ - 1 , {y}^{′} ] + nS ) >> ( k + 1 )$$

wherein p[x,y] denotes a pixel value of a pixel at position x,y=0 . . . nS−1 within the intra-predicted block of pixels, k=log 2(nS), nS represents a width and height of the intra-predicted block of pixels and >> represents a right shift operator defined as

$$a >> b = ⌊ \frac{a}{{2}^{b}} ⌋$$

and └c┘ is a largest integer not greater than c.

In a particular embodiment, the application of filtering to the top-most and the left-most pixels is restricted to filtering luma components. This can be verified by checking the value of a chroma component index, cIdx. If this chroma component index has a value of zero then the pixel values are luma components.

Hence, a next step S32 comprises checking whether cIdx=0 and whether nS<32, i.e. if the block size of the intra-predicted block of pixel in terms of width and height is smaller than the specified threshold, which is equal to 32 pixels in this embodiment.

If cIdx=0 and nS<32 the method continues to step S33 where the top-most and the left-most pixels of the intra-predicted block of pixels are filtered. This filtering preferably comprises determining predicted sample values, predSamples[x,y], of the pixels in the intra-predicted block of pixels to be:

predSamples[0,0]=(1×p[−1,0]+2×DCVal+1×p[0,−1]+2)>>2

predSamples[x,0]=(1×p[x,−1]+3×DCVal+2)>>2, with x=1 . . . nS−1

predSamples[0,y]=(1×p[−1,y]+3DCVal+2)>>2, with y=1 . . . nS−1

predSamples[x,y]=DCVal, with x,y=1 . . . nS−1

Correspondingly, if cIdx #0 and/or nS 32, i.e. for chroma components or for luma components with a block size (height and width) that is equal to or larger than 32 pixels, the method continues to step S34 where no filtering is applied to the top-most or left-most pixels. Hence, the predicted sample values of the pixels in the intra-predicted block of pixels are determined to be:

predSamples[x,y]=DCVal, with x,y=0 . . . nS−1

In an alternative embodiment, step S32 comprises checking whether cIdx=0 and whether nS<16, i.e. if the block size of the intra-predicted block of pixel in terms of width and height is smaller than the specified threshold, which is equal to 16 pixels in this embodiment.

In another alternative embodiment, step S32 comprises checking whether cIdx=0 and whether log 2(nS)<5. This alternative embodiment is basically the same as checking whether nS<32.

In a further alternative embodiment, step S32 comprises checking whether cIdx=0 and whether log 2(nS)<4. This alternative embodiment is basically the same as checking whether nS<16.

These embodiments are summarized below as embodiments 1-5.

### Embodiment 1

Prediction in the DC mode is done as in the following.

A variable DCVal is derived as the average of the neighboring pixels:

$$DCVal = ( {\sum }_{{x}^{′} = 0}^{nS - 1} p [ {x}^{′} , - 1 ] + {\sum }_{{y}^{′} = 0}^{nS - 1} p [ - 1 , {y}^{′} ] + nS ) >> ( k + 1 )$$

with x,y=0 . . . nS−1, where k=log 2(nS), the nS being block width/height.

Depending on the chroma component index cIdx, the following applies.

If cIdx is equal to 0 and log 2(nS) is smaller than 4, the following applies.

predSamples[0,0]=(1×p[−1,0]+2×DCVal+1×p[0,−1]+2)>>2

predSamples[x,0]=(1×p[x,−1]+3×DCVal+2)>>2, with x=1 . . . nS−1

predSamples[0,y]=(1×p[−1,y]+3×DCVal+2)>>2, with y=1 . . . nS−1

predSamples[x,y]=DCVal, with x,y=1 . . . nS−1

Otherwise, the prediction samples predSamples[x,y] are derived as

predSamples[x,y]=DCVal, with x,y=0 . . . nS−1

### Embodiment 2

Prediction in the DC mode is done as in the following.

A variable DCVal is derived as the average of the neighboring pixels:

$$DCVal = ( {\sum }_{{x}^{′} = 0}^{nS - 1} p [ {x}^{′} , - 1 ] + {\sum }_{{y}^{′} = 0}^{nS - 1} p [ - 1 , {y}^{′} ] + nS ) >> ( k + 1 )$$

with x,y=0 . . . nS−1, where k=log 2(nS), the nS being block width/height

Depending on the chroma component index cIdx, the following applies.

If cIdx is equal to 0 and log 2(nS) is smaller than 5, the following applies.

predSamples[0,0]=(1×p[−1,0]+2×DCVal+1×p[0,−1]+2)>>2

predSamples[x,0]=(1×p[x,−1]+3×DCVal+2)>>2, with x=1 . . . nS−1

predSamples[0,y]=(1×p[−1,y]+3×DCVal+2)>>2, with y=1 . . . nS−1

predSamples[x,y]=DCVal, with x,y=1 . . . nS−1

Otherwise, the prediction samples predSamples[x,y] are derived as

predSamples[x,y]=DCVal, with x,y=0 . . . nS−1

### Embodiment 3

Prediction in the DC mode is done as in the following.

A variable DCVal is derived as the average of the neighboring pixels:

$$DCVal = ( {\sum }_{{x}^{′} = 0}^{nS - 1} p [ {x}^{′} , - 1 ] + {\sum }_{{y}^{′} = 0}^{nS - 1} p [ - 1 , {y}^{′} ] + nS ) >> ( k + 1 )$$

with x,y=0 . . . nS−1, where k=log 2(nS), the nS being block width/height

Depending on the chroma component index cIdx, the following applies.

If cIdx is equal to 0 and nS is smaller than 32, the following applies.

predSamples[0,0]=(1×p[−1,0]+2×DCVal+1×p[0,−1]+2)>>2

predSamples[x,0]=(1×p[x,−1]+3×DCVal+2)>>2, with x=1 . . . nS−1

predSamples[0,y]=(1×p[−1,y]+3×DCVal+2)>>2, with y=1 . . . nS−1

predSamples[x,y]=DCVal, with x,y=1 . . . nS−1

Otherwise, the prediction samples predSamples[x,y] are derived as

predSamples[x,y]=DCVal, with x,y=0 . . . nS−1

### Embodiment 4

Prediction in the DC mode is done as in the following.

A variable DCVal is derived as the average of the neighboring pixels:

$$DCVal = ( {\sum }_{{x}^{′} = 0}^{nS - 1} p [ {x}^{′} , - 1 ] + {\sum }_{{y}^{′} = 0}^{nS - 1} p [ - 1 , {y}^{′} ] + nS ) >> ( k + 1 )$$

with x,y=0 . . . nS−1, where k=log 2(nS), the nS being block width/height

Depending on the chroma component index cIdx, the following applies.

If cIdx is equal to 0 and nS is smaller than 16, the following applies.

predSamples[0,0]=(1×p[−1,0]+2×DCVal+1×p[0,−1]+2)>>2

predSamples[x,0]=(1×p[x,−1]+3×DCVal+2)>>2, with x=1 . . . nS−1

predSamples[0,y]=(1×p[−1,y]+3×DCVal+2)>>2, with y=1 . . . nS−1

predSamples[x,y]=DCVal, with x,y=1 . . . nS−1

Otherwise, the prediction samples predSamples[x,y] are derived as

predSamples[x,y]=DCVal, with x,y=0 . . . nS−1

### Embodiment 5

The values of the prediction samples predSamples[x][y], with x,y=0 . . . nTbS−1, are derived by the following ordered steps:

A variable dcVal is derived as follows:

$$dcVal = ( {\sum }_{{x}^{′} = 0}^{nTbS - 1} p [ {x}^{′} ] [ - 1 ] + {\sum }_{{y}^{′} = 0}^{nTbS - 1} p [ - 1 ] [ {y}^{′} ] + nTbS ) >> ( k + 1 )$$

where k=log 2(nTbS), the nTbs being block width/height.

Depending on the value of the colour component index cIdx, the following applies:

If cIdx is equal to 0 and nTbS is less than 32, the following applies:

predSamples[0][0]=(p[−1][0]+2×dcVal+p[0][−1]+2)>>2

predSamples[x][0]=(p[x][−1]+3×dcVal+2)>>2, with x=1 . . . nTbS−1

predSamples[0][y]=(p[−1][y]+3×dcVal+2)>>2, with y=1 . . . nTbS−1

predSamples[x][y]=dcVal, with x,y=1 . . . nTbS−1

Otherwise, the prediction samples predSamples[x][y] are derived as follows:

predSamples[x][y]=dcVal, with x,y=0 . . . nTbS−1

In an embodiment the filtering control method further comprises determining, in step S40 of FIG. 10, that the intra-predicted block of pixels is intra-predicted according to the vertical prediction mode. In such a case, step S3 of FIG. 18 preferably comprises determining whether to apply filtering of the left-most pixels in the DC intra-predicted block of pixels based on the comparison of the block size to the specified threshold.

Thus, it is proposed in this embodiment to apply filtering, such as averaging with neighboring/reference samples, of the left-most pixels or samples in the intra-predicted block only for the blocks of the smaller size in the vertical prediction mode. Therefore, before applying the filtering to the left-most samples of the intra-predicted block, a check for the block size should be done. The filtering is applied only if the block size is below a specified threshold. Otherwise, filtering is not applied.

It is proposed to restrict application of the filtering of the border pixels or samples to the block, the size of which is smaller than 16×16 pixels or samples. Alternatively, it is proposed to restrict the application of the filtering of the border pixels or samples to a block having a block size that is smaller than 32×32 pixels or samples.

FIG. 10 is a flow diagram illustrating an embodiment of steps S2-S3 in FIG. 18 and steps S4-S5 in FIG. 19 for an intra-predicted block of pixels having vertical prediction mode (Intra_angular[k] with k=26) as intra prediction mode.

The method continues from step S1 of FIG. 18 or from steps S30 or S50 in FIG. 9 or 11. A first step S40 comprises, which has already been discussed in the foregoing, determining that the intra-predicted block of pixels is intra-predicted according to the vertical prediction mode. This step S40 can be performed based on the intra-prediction mode number or identifier assigned to or determined for the intra-predicted block of pixels.

If it is not predicted according to the vertical prediction mode the method ends or continues to steps S30 or S50 in FIG. 9 or 11. If the intra-predicted block of pixels is predicted according to the vertical prediction mode the method continues to step S41.

In a particular embodiment, the application of filtering to the left-most pixels is restricted to filtering luma components. This can be verified by checking the value of cIdx.

Step S41 comprises checking whether cIdx=0 and whether nS<32, i.e. if the block size of the intra-predicted block of pixel in terms of width and height is smaller than the specified threshold, which is equal to 32 pixels in this embodiment.

If cIdx=0 and nS<32 the method continues to step S42 where the left-most pixels of the intra-predicted block of pixels are filtered. This filtering preferably comprises determining predicted sample values, predSamples[x,y], of the pixels in the intra-predicted block of pixels to be:

predSamples[0,y]=Clip1_{Y}(p[0,−1]+(p[−1,y]−p[−1,−1])>>1), with y=0 . . . nS−1

predSamples[x,y]=p[x,−1], with x=1 . . . nS−1, y=0 . . . nS−1

Clip1_{Y}( ) is a clipping function defined as Clip1_{Y}(d)=Clip3(0,(1<<BitDepth_{Y})−1,d), BitDepth_{Y} denotes bit depth of the luma components, << represents a left shift operator defined as

$$a << b = a \times {2}^{b} and Clip 3 ( e , f , g ) = \{ \begin{matrix}e , & if g < e \\ f , & if g > f \\ g , & otherwise\end{matrix} \} .$$

Correspondingly, if cIdx≠0 and/or nS≧32, i.e. for chroma components or for luma components with a block size (height and width) that is equal to or larger than 32 pixels, the method continues to step S43 where no filtering is applied to the left-most pixels (or indeed to the top-most pixels). Hence, the predicted sample values of the pixels in the intra-predicted block of pixels are determined to be:

predSamples[x,y]=p[x,−1], with x,y=0 . . . nS−1

In an alternative embodiment, step S41 comprises checking whether cIdx=0 and whether nS<16, i.e. if the block size of the intra-predicted block of pixel in terms of width and height is smaller than the specified threshold, which is equal to 16 pixels in this embodiment.

In another alternative embodiment, step S41 comprises checking whether cIdx=0 and whether log 2(nS)<5. This alternative embodiment is basically the same as checking whether nS<32.

In a further alternative embodiment, step S41 comprises checking whether cIdx=0 and whether log 2(nS)<4. This alternative embodiment is basically the same as checking whether nS<16.

These embodiments are summarized below as embodiments 6-10.

### Embodiment 6

Prediction in the vertical prediction mode (mode 26) is done as in the following.

The values of the predicted samples predSamples[x,y], with x,y=0 . . . nS−1, where nS is the predicted block size, are derived as follows:

If cIdx is equal to 0 and log 2(nS) is smaller than 4,

predSamples[x,y]=p[x,−1], with x=1 . . . nS−1, y=0 . . . nS−1

predSamples[x,y]=Clip1Y(p[x,−1]+((p[−1,y]−p[−1,−1])>>1)), with x=0,y=0 . . . nS−1

Otherwise,

predSamples[x,y]=p[x,−1], with x,y=0 . . . nS−1

### Embodiment 7

Prediction in the vertical prediction mode (mode 26) is done as in the following.

The values of the predicted samples predSamples[x,y], with x,y=0 . . . nS−1, where nS is the predicted block size, are derived as follows:

If cIdx is equal to 0 and log 2(nS) is smaller than 5,

predSamples[x,y]=p[x,−1], with x=1 . . . nS−1, y=0 . . . nS−1

predSamples[x,y]=Clip1Y(p[x,−1]+((p[−1,y]−p[−1,−1])>>1)), with x=0,y=0 . . . nS−1

Otherwise,

predSamples[x,y]=p[x,−1], with x,y=0 . . . nS−1

### Embodiment 8

Prediction in the vertical prediction mode (mode 26) is done as in the following.

The values of the predicted samples predSamples[x,y], with x,y=0 . . . nS−1, are derived as follows:

If cIdx is equal to 0 and nS is smaller than 16,

predSamples[x,y]=p[x,−1], with x=1 . . . nS−1, y=0 . . . nS−1

predSamples[x,y]=Clip1Y(p[x,−1]+((p[−1,y]−p[−1,−1])>>1)), with x=0, y=0 . . . nS−1

Otherwise,

predSamples[x,y]=p[x,−1], with x,y=0 . . . nS−1

### Embodiment 9

Prediction in the vertical prediction mode (mode 26) is done as in the following.

The values of the predicted samples predSamples[x,y], with x,y=0 . . . nS−1, where nS is the predicted block size, are derived as follows:

If cIdx is equal to 0 and nS is smaller than 32,

predSamples[x,y]=p[x,−1], with x=1 . . . nS−1, y=0 . . . nS−1

predSamples[x,y]=Clip1Y(p[x,−1]+((p[−1,y]−p[−1,−1])>>1)), with x=0,y=0 . . . nS−1

Otherwise,

predSamples[x,y]=p[x,−1], with x,y=0 . . . nS−1

### Embodiment 10

The values of the prediction samples predSamples[x][y], with x,y=0 . . . nTbS−1 are derived as follows:

If predModeIntra is equal or greater than 18, the following ordered steps apply:

The reference sample array ref[x] is specified as follows:

The following applies:

ref[x]=p[−1+x][−1], with x=0 . . . nTbS

If intraPredAngle is less than 0, the main reference sample array is extended as follows:
When (nTbS×intraPredAngle)>>5 is less than −1,

ref[x]=p[−1][−1+((x×invAngle+128)>>8)],
with x=−1 . . . (nTbS*intraPredAngle)>>5

Otherwise,

ref[x]=p[−1+x][−1], with x=nTbS+1 . . . 2×nTbS

The values of the prediction samples predSamples[x][y], with x,y=0 . . . nTbS−1 are derived as follows:

The index variable iIdx and the multiplication factor iFact are derived as follows:

iIdx=((y+1)×intraPredAngle)>>5

iFact=((y+1)×intraPredAngle)& 31

Depending on the value of iFact, the following applies:
If iFact is not equal to 0, the value of the prediction samples predSamples[x][y] is derived as follows:

predSamples[x][y]=((32−iFact)×ref[x+iIdx+1]+iFact×ref[x+iIdx+2]+16)>>5
Otherwise, the value of the prediction samples predSamples[x][y] is derived as follows:

predSamples[x][y]=ref[x+iIdx+1]

When predModeIntra is equal to 26 (vertical), cIdx is equal to 0 and nTbS is less than 32, the following filtering applies with x=0, y=0 . . . nTbS−1:

predSamples[x][y]=Clip1_{Y}(p[x][−1]+((p[−1][y]−p[−1][−1])>>1))

In an embodiment the filtering control method further comprises determining, in step S50 of FIG. 11, that the intra-predicted block of pixels is intra-predicted according to the horizontal prediction mode. In such a case, step S3 of FIG. 18 preferably comprises determining whether to apply filtering of the top-most pixels in the DC intra-predicted block of pixels based on the comparison of the block size to the specified threshold.

Thus, it is proposed in this embodiment to apply filtering, such as averaging with neighboring/reference samples, of the top-most pixels or samples in the intra-predicted block only for the blocks of the smaller size in the horizontal prediction mode. Therefore, before applying the filtering to the top-most samples of the intra-predicted block, a check for the block size should be done. The filtering is applied only if the block size is below a specified threshold. Otherwise, filtering is not applied.

It is proposed to restrict application of the filtering of the border pixels or samples to the block, the size of which is smaller than 16×16 pixels or samples. Alternatively, it is proposed to restrict the application of the filtering of the border pixels or samples to a block having a block size that is smaller than 32×32 pixels or samples.

FIG. 11 is a flow diagram illustrating an embodiment of steps S2-S3 in FIG. 18 and steps S4-S5 in FIG. 19 for an intra-predicted block of pixels having horizontal prediction mode (Intra_angular[k] with k=10) as intra prediction mode.

The method continues from step S1 of FIG. 18 or from steps S30 or S40 in FIG. 9 or 10. A first step S50 comprises, which has already been discussed in the foregoing, determining that the intra-predicted block of pixels is intra-predicted according to the horizontal prediction mode. This step S40 can be performed based on the intra-prediction mode number or identifier assigned to or determined for the intra-predicted block of pixels.

If it is not predicted according to the vertical prediction mode the method ends or continues to steps S30 or S40 in FIG. 9 or 10. If the intra-predicted block of pixels is predicted according to the horizontal prediction mode the method continues to step S51.

In a particular embodiment, the application of filtering to the top-most pixels is restricted to filtering luma components. This can be verified by checking the value of cIdx.

Step S51 comprises checking whether cIdx=0 and whether nS<32, i.e. if the block size of the intra-predicted block of pixel in terms of width and height is smaller than the specified threshold, which is equal to 32 pixels in this embodiment.

If cIdx=0 and nS<32 the method continues to step S52 where the top-most pixels of the intra-predicted block of pixels are filtered. This filtering preferably comprises determining predicted sample values, predSamples[x,y], of the pixels in the intra-predicted block of pixels to be:

predSamples[x,0]=Clip1_{Y}(p[−1,0]+(p[x,−1]−p[−1,−1])>>1), with x=0 . . . nS−1

predSamples[x,y]=p[−1,y], with x=0 . . . nS−1, y=1 . . . nS−1

Correspondingly, if cIdx #0 and/or nS 32, i.e. for chroma components or for luma components with a block size (height and width) that is equal to or larger than 32 pixels, the method continues to step S53 where no filtering is applied to the top-most pixels (or indeed to the left-most pixels). Hence, the predicted sample values of the pixels in the intra-predicted block of pixels are determined to be:

predSamples[x,y]=p[−1,y], with x,y=0 . . . nS−1

In an alternative embodiment, step S51 comprises checking whether cIdx=0 and whether nS<16, i.e. if the block size of the intra-predicted block of pixel in terms of width and height is smaller than the specified threshold, which is equal to 16 pixels in this embodiment.

In another alternative embodiment, step S51 comprises checking whether cIdx=0 and whether log 2(nS)<5. This alternative embodiment is basically the same as checking whether nS<32.

In a further alternative embodiment, step S51 comprises checking whether cIdx=0 and whether log 2(nS)<4. This alternative embodiment is basically the same as checking whether nS<16.

These embodiments are summarized below as embodiments 11-15.

### Embodiment 11

Prediction in the horizontal prediction mode (mode 10) is done as in the following.

The values of the prediction samples predSamples[x,y], with x,y=0 . . . nS−1, where nS is the predicted block size, are derived as follows:

If cIdx is equal to 0 and log 2(nS) is smaller than 4,

predSamples[x,y]=p[−1,y], with x=0 . . . nS−1, y=1 . . . nS−1

predSamples[x,y]=Clip1Y(p[−1,y]+((p[x,−1]−p[−1,−1])>>1), with x=0 . . . nS−1, y=0

Otherwise,

predSamples[x,y]=p[−1,y], with x,y=0 . . . nS−1

### Embodiment 12

Prediction in the horizontal prediction mode (mode 10) is done as in the following.

The values of the prediction samples predSamples[x,y], with x,y=0 . . . nS−1, where nS is the predicted block size, are derived as follows:

If cIdx is equal to 0 and log 2(nS) is smaller than 5,

predSamples[x,y]=p[−1,y], with x=0 . . . nS−1, y=1 . . . nS−1

predSamples[x,y]=Clip1Y(p[−1,y]+((p[x,−1]−p[−1,−1])>>1), with x=0 . . . nS−1, y=0

Otherwise,

predSamples[x,y]=p[−1,y], with x,y=0 . . . nS−1

### Embodiment 13

Prediction in the horizontal prediction mode (mode 10) is done as in the following.

The values of the prediction samples predSamples[x,y], with x,y=0 . . . nS−1, where nS is the predicted block size, are derived as follows:

If cIdx is equal to 0 and nS is smaller than 32,

predSamples[x,y]=p[−1,y], with x=0 . . . nS−1, y=1 . . . nS−1

predSamples[x,y]=Clip1Y(p[−1,y]+((p[x,−1]−p[−1,−1])>>1), with x=0 . . . nS−1, y=0

Otherwise,

predSamples[x,y]=p[−1,y], with x,y=0 . . . nS−1

### Embodiment 14

Prediction in the horizontal prediction mode (mode 10) is done as in the following.

The values of the prediction samples predSamples[x,y], with x,y=0 . . . nS−1, where nS is the predicted block size, are derived as follows:

If cIdx is equal to 0 and nS is smaller than 16,

predSamples[x,y]=p[−1,y], with x=0 . . . nS−1, y=1 . . . nS−1

predSamples[x,y]=Clip1Y(p[−1,y]+((p[x,−1]−p[−1,−1])>>1), with x=0 . . . nS−1, y=0

Otherwise,

predSamples[x,y]=p[−1,y], with x,y=0 . . . nS−1

### Embodiment 15

The values of the prediction samples predSamples[x][y], with x,y=0 . . . nTbS−1 are derived as follows:

Otherwise (predModeIntra is less than 18, see embodiment 10), the following ordered steps apply:

The reference sample array ref[x] is specified as follows:

The following applies:

ref[x]=p[−1][−1+x], with x=0 . . . nTbS

If intraPredAngle is less than 0, the main reference sample array is extended as follows:
When (nTbS×intraPredAngle)>>5 is less than −1,

ref[x]=p[−1+((x×invAngle+128)>>8)][−1],
with x=−1 . . . (nTbS×intraPredAngle)>>5

Otherwise,

ref[x]=p[−1][−1+x], with x=nTbS+1 . . . 2×nTbS

The values of the prediction samples predSamples[x][y], with x,y=0 . . . nTbS−1 are derived as follows:

The index variable iIdx and the multiplication factor iFact are derived as follows:

iIdx=((x+1)×intraPredAngle)>>5

iFact=((x+1)×intraPredAngle)& 31

Depending on the value of iFact, the following applies:
If iFact is not equal to 0, the value of the prediction samples predSamples[x][y] is derived as follows:

predSamples[x][y]=((32−iFact)×ref[y+iIdx+1]+iFact×ref[y+iIdx+2]+16)>>5
Otherwise, the value of the prediction samples predSamples[x][y] is derived as follows:

predSamples[x][y]=ref[y+iIdx+1]

When predModeIntra is equal to 10 (horizontal), cIdx is equal to 0 and nTbS is less than 32, the following filtering applies with x=0 . . . nTbS−1, y=0:

predSamples[x][y]=Clip1_{Y}(p[−1][y]+((p[x][−1]−p[−1][−1])>>1))

The embodiments 1-15 above are examples of the proposed intra-prediction modifications. These examples are, however, not restrictive. For example, different values of thresholds for the predicted block sizes can be used. Moreover, the criteria for the applying the modification of the border samples in the mentioned prediction modes can also be used in combination with some other criteria. The same embodiments can also be applied with other intra prediction modes (intra prediction directions).

The proposed embodiments improve the subjective quality of (HEVC) intra-prediction in DC, vertical and horizontal prediction modes, while still keeping the objective gains brought by filtering, i.e. weighted averaging of the predicted values with the neighboring sample values.

FIGS. 1B and 10 illustrate method steps performed in a transmitter and a receiver, respectively. Step S10 of FIG. 1B comprises sending signaling according to embodiments and step S20 of FIG. 10 correspondingly comprises receiving signaling according to embodiments. The sent signaling in step S10 corresponds to a video bit-stream, i.e. encoded representations of pictures in the video sequence. The received signaling in step S20 corresponds to the reception of this video bit-stream.

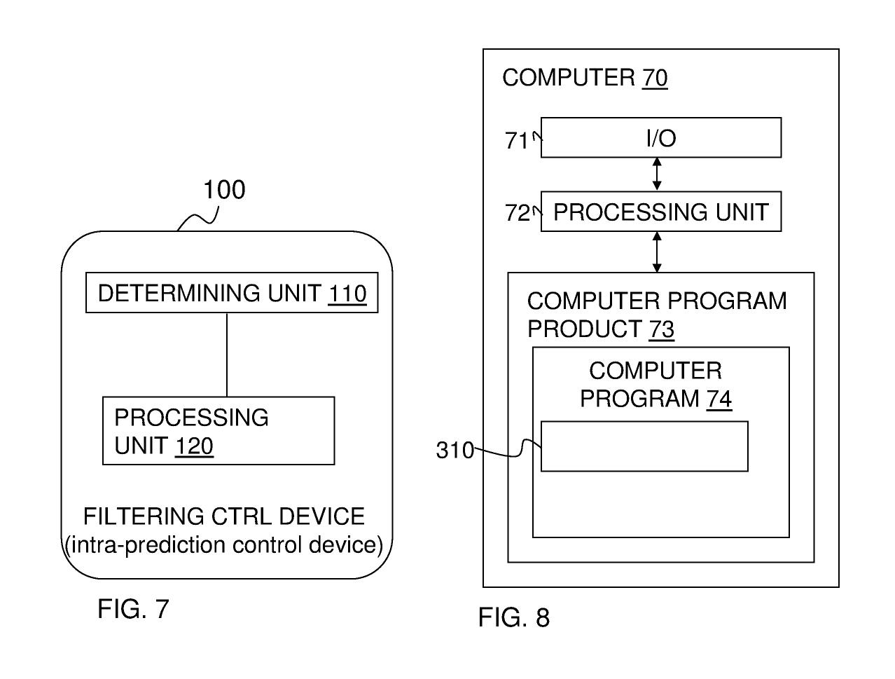

The filtering control method of the embodiments is advantageously implemented in a filtering control device or, as shown in FIG. 1A, in an intra prediction control device. FIG. 7 is a schematic block diagram of such a filtering control device 100 (intra-prediction control device). The filtering control device 100 generally comprises a determining unit 110, also referred to as determiner, determining module or means, and a processing unit 120, also referred to as processor, processing module or means.

The processing unit 120 is configured to check a block size of an intra-predicted block of pixels in a picture in a video sequence. The processing unit 120 is also configured to compare the block size to a specified threshold. The determining unit 110 is configured to determine whether to apply filtering of top-most and/or left-most pixels in the intra-predicted block of pixels based on the comparison of the block size to the specified threshold.

In an implementation embodiment, the filtering control device comprises means for checking a block size of an intra-predicted block of pixels in a picture in a video sequence. The filtering control device also comprises means for comparing the block size to a specified threshold and means for determining whether to apply filtering of top-most and/or left-most pixels in the intra-predicted block of pixels based on the comparison of the block size to the specified threshold.

In an embodiment, the processing unit 120 is configured to apply filtering of the top-most and/or the left-most pixels in the intra-predicted block of pixels if the block size is smaller than the specified threshold. The processing unit 110 is preferably also configured to prevent applying filtering of the top-most and/or left-most pixels in the intra-predicted block of pixels if the block size is not smaller than the specified threshold.

In an embodiment, the determining unit 110 is configured to determine, for luma components of the pixels, whether to apply filtering of top-most and/or left-most pixel sin the intra-predicted block of pixels based on the comparison of the block size to the specified threshold.

In an embodiment, the determining unit 110 is configured to determine that the intra-predicted block of pixels is intra-predicted according to a DC prediction mode. The determining unit 110 is also configured, in this embodiment, to determine whether to apply filtering of the top-most and the left-most pixels in the intra-predicted block of pixels based on the comparison of the block size to the specified threshold.

In a particular embodiment applicable to DC intra-predicted blocks of pixels, the processing unit 120 is configured to calculate a variable

$$DCVal = ( {\sum }_{{x}^{′} = 0}^{nS - 1} p [ {x}^{′} , - 1 ] + {\sum }_{{y}^{′} = 0}^{nS - 1} p [ - 1 , {y}^{′} ] + nS ) >> ( k + 1 ) .$$

The determining unit 110 is configured to determine, if cIdx=0 and nS<32, predicted sample values of the pixels in the intra-predicted block of pixels to be:

predSamples[0,0]=(1×p[−1,0]+2×DCVal+1×p[0,−1]+2)>>2

predSamples[x,0]=(1×p[x,−1]+3×DCVal+2)>>2, with x=1 . . . nS−1

predSamples[0,y]=(1×p[−1,y]+3DCVal+2)>>2, with y=1 . . . nS−1

predSamples[x,y]=DCVal, with x,y=1 . . . nS−1

and otherwise determine the predicted sample values to be:

predSamples[x,y]=DCVal, with x,y=0 . . . nS−1.

In an embodiment, the determining unit 110 is configured to determine that the intra-predicted block of pixels is intra-predicted according to a vertical prediction mode. The determining unit 110 is also configured, in this embodiment, to determine whether to apply filtering of the left-most pixels in the intra-predicted block of pixels based on the comparison of the block size to the specified threshold.

In a particular embodiment applicable to vertically intra-predicted block of pixels, the determining unit 110 is configured to determine, if cIdx=0 and nS<32, predicted sample values of the pixels in said intra-predicted block of pixels to be:

predSamples[0,y]=Clip1_{Y}(p[0,−1]+(p[−1,y]−p[−1,−1])>>1), with y=0 . . . nS−1

predSamples[x,y]=p[x,−1], with x=1 . . . nS−1, y=0 . . . nS−1

and otherwise determine said predicted sample values to be:

predSamples[x,y]=p[x,−1], with x,y=0 . . . nS−1.

In an embodiment, the determining unit 110 is configured to determine that the intra-predicted block of pixels is intra-predicted according to a horizontal prediction mode. The determining unit 110 is also configured, in this embodiment, to, determine whether to apply filtering of the top-most pixels in the intra-predicted block of pixels based on the comparison of the block size to the specified threshold.

In a particular embodiment applicable to horizontally intra-predicted block of pixels, the determining unit 110 is configured to determine, if cIdx=0 and nS<32, predicted sample values of the pixels in the intra-predicted block of pixels to be:

predSamples[x,0]=Clip1_{Y}(p[−1,0]+(p[x,−1]−p[−1,−1])>>1), with x=0 . . . nS−1

predSamples[x,y]=p[−1,y], with x=0 . . . nS−1, y=1 . . . nS−1

and otherwise determine the predicted sample values to be:

predSamples[x,y]=p[−1,y], with x,y=0 . . . nS−1.

Accordingly as illustrated in FIG. 7, the filtering control device 100 (intra prediction control device) implements the functions of embodiments 1-15 or a combination thereof.

The filtering control device 100 of FIG. 7 with its including units 110-120 could be implemented in hardware. There are numerous variants of circuitry elements that can be used and combined to achieve the functions of the units 110-120 of the filtering control device 100. Such variants are encompassed by the embodiments. Particular examples of hardware implementation of the filtering control device 100 is implementation in digital signal processor (DSP) hardware and integrated circuit technology, including both general-purpose electronic circuitry and application-specific circuitry.

The filtering control device 100 described herein could alternatively be implemented e.g. by one or more of a processing unit 72 in a computer 70 and adequate software with suitable storage or memory therefore, a programmable logic device (PLD) or other electronic component(s) as shown in FIG. 8.

FIG. 8 schematically illustrates an embodiment of a computer 70 having a processing unit 72, such as a DSP (Digital Signal Processor) or CPU (Central Processing Unit). The processing unit 72 can be a single unit or a plurality of units for performing different steps of the method described herein. The computer 70 also comprises an input/output (I/O) unit 71 for receiving recorded or generated video frames or pictures or encoded video frames or pictures and outputting encoded video frame or pictures or decoded video data. The I/O unit 71 has been illustrated as a single unit in FIG. 8 but can likewise be in the form of a separate input unit and a separate output unit.

Furthermore, the computer 70 comprises at least one computer program product 73 in the form of a non-volatile memory, for instance an EEPROM (Electrically Erasable Programmable Read-Only Memory), a flash memory or a disk drive. The computer program product 73 comprises a computer program 74, which comprises code means which when run on or executed by the computer 70, such as by the processing unit 72, causes the computer 70 to perform the steps of the method described in the foregoing in connection with FIG. 1A. Hence, in an embodiment the code means in the computer program 74 comprises a module 310 configured to implement embodiments 1-12 or combinations thereof. This module 310 essentially performs the steps of the flow diagrams in FIG. 1A when run on the processing unit 72. Thus, when the module 310 is run on the processing unit 72 it corresponds to the corresponding units 110-120 of FIG. 7.

An embodiment therefore relates to a computer program 74 for filtering control. The computer program 74 comprises code means which, when executed by a processing unit 72, causes the processing unit 72 to check a block size of an intra-predicted block of pixels of a picture in a video sequence. The code means also causes the processing unit 72 to compare the block size to a specified threshold. The code means further causes the processing unit 72 to determine whether to apply filtering of top-most and/or left-most pixels in the intra-predicted block of pixels based on the comparison of the block size to a specified threshold.

Another embodiment relates to a computer program product 73 comprising computer readable code means and a computer program 74 according to above stored on the computer readable code means.

The solution, including the embodiments above, applies to a decoder or an encoder. The encoder may for example be located in a transmitter in a video camera in e.g. a mobile device. The decoder may for example be located in a receiver in a video camera or any other device for displaying, decoding or transcoding a video stream.

Hence, an embodiment relates to an encoder comprising a filtering control device as disclosed above in connection with FIG. 7.

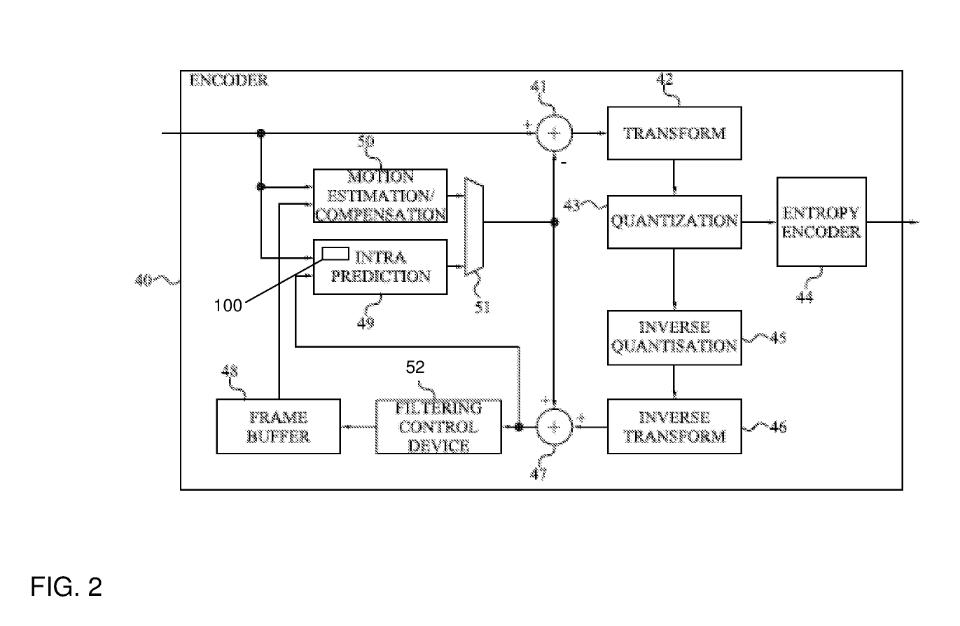

FIG. 2 is a schematic block diagram of an encoder 40 for encoding a block of pixels in a picture or video frame of a video sequence according to an embodiment.

A current block of pixels is predicted by performing a motion estimation by a motion estimator 50 from an already provided block of pixels in the same frame or in a previous frame. The result of the motion estimation is a motion or displacement vector associated with the reference block, in the case of inter prediction. The motion vector is utilized by a motion compensator 50 for outputting an inter prediction of the block of pixels.

An intra predictor 49 computes an intra prediction of the current block of pixels. The outputs from the motion estimator/compensator 50 and the intra predictor 49 are input in a selector 51 that either selects intra prediction or inter prediction for the current block of pixels. The output from the selector 51 is input to an error calculator in the form of an adder 41 that also receives the pixel values of the current block of pixels. The adder 41 calculates and outputs a residual error as the difference in pixel values between the block of pixels and its prediction.

The error is transformed in a transformer 42, such as by a discrete cosine transform, and quantized by a quantizer 43 followed by coding in an encoder 44, such as by entropy encoder. In inter coding, also the estimated motion vector is brought to the encoder 44 for generating the coded representation of the current block of pixels.

The transformed and quantized residual error for the current block of pixels is also provided to an inverse quantizer 45 and inverse transformer 46 to retrieve the original residual error. This error is added by an adder 47 to the block prediction output from the motion compensator 50 or the intra predictor 49 to create a reference block of pixels that can be used in the prediction and coding of a next block of pixels. This new reference block is first processed by a filtering control device 52 in order to control any filtering that is applied to the reference block to combat any artifact. The processed new reference block is then temporarily stored in a frame buffer 48, where it is available to the intra predictor 49 and the motion estimator/compensator 50.

The encoder 40 preferably comprises a filtering control device 100 (intra prediction control device) according to the embodiments. The filtering control device 100 of the embodiment is preferably implemented in the intra predictor 49.

Hence, in an embodiment the encoder 40 comprises a filtering control device 100 of the embodiments to achieve intra-prediction boundary filtering, preferably implemented in the intra predictor 49, and a second filtering control device 52 that achieves in-loop filtering, i.e. deblocking filtering.

An embodiment relates to a decoder comprising a filtering control device as disclosed above in connection with FIG. 7.

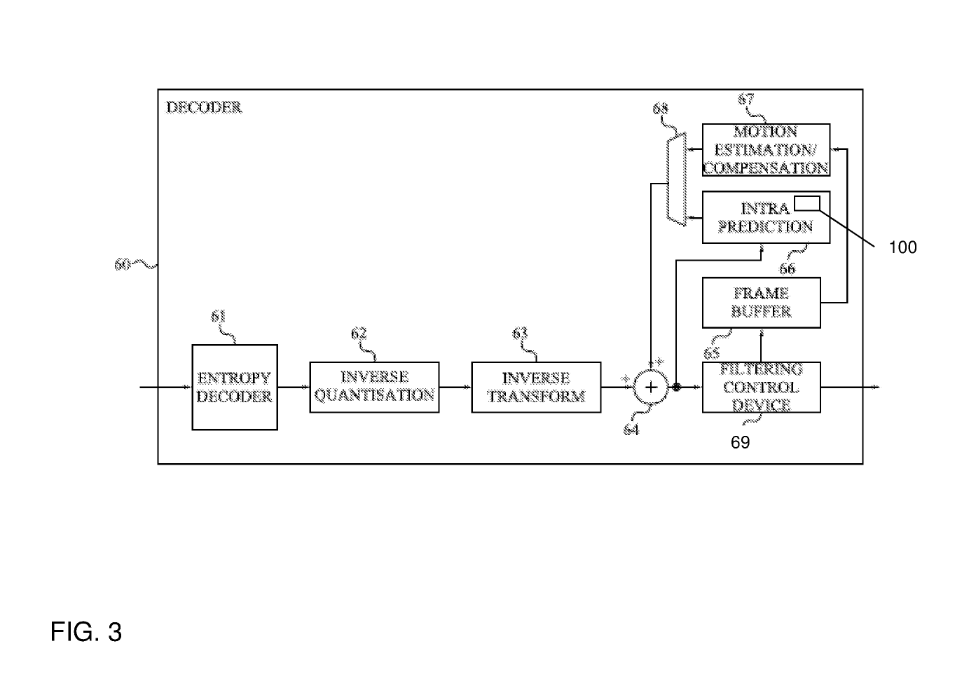

FIG. 3 is a corresponding schematic block diagram of a decoder 60 comprising a filtering control device (intra prediction control device) 100 according to any of the embodiments or in combinations thereof. The decoder 60 comprises a decoder 61, such as entropy decoder, for decoding an encoded representation of a block of pixels to get a set of quantized and transformed residual errors. These residual errors are de-quantized in an inverse quantizer 62 and inverse transformed by an inverse transformer 63 to get a set of residual errors.

These residual errors are added in an adder 64 to the pixel values of a reference block of pixels. The reference block is determined by a motion estimator/compensator 67 or intra predictor 66, depending on whether inter or intra prediction is performed. A selector 68 is thereby interconnected to the adder 64 and the motion estimator/compensator 67 and the intra predictor 66. The resulting decoded block of pixels output from the adder 64 is input to a filtering control device 69 in order to control any filter that is applied to combat any artifacts. The filtered block of pixels is output form the decoder 60 and is furthermore preferably temporarily provided to a frame buffer 65 and can be used as a reference block of pixels for a subsequent block of pixels to be decoded. The frame buffer 65 is thereby connected to the motion estimator/compensator 67 to make the stored blocks of pixels available to the motion estimator/compensator 67.

The output from the adder 64 is preferably also input to the intra predictor 66 to be used as an unfiltered reference block of pixels.

The decoder 60 preferably comprises a filtering control device 100 (intra prediction control device) according to the embodiments. The filtering control device 100 of the embodiment is preferably implemented in the intra predictor 66.

Hence, in an embodiment the decoder 60 comprises a filtering control device 100 of the embodiments to achieve intra-prediction boundary filtering, preferably implemented in the intra predictor 66, and a second filtering control device 69 that achieves in-loop filtering, i.e. deblocking filtering.

In the embodiments disclosed in FIGS. 2 and 3 the second filtering control device 52, 69 controls filtering in the form of so called in-loop filtering. In an alternative implementation at the decoder 60 the filtering control device 52, 69 is arranged to perform so called post-processing filtering. In such a case, the filtering control device 52, 69 operates on the output frames outside of the loop formed by the adder 64, the frame buffer 65, the intra predictor 66, the motion estimator/compensator 67 and the selector 68. No filtering and filter control is then typically done at the encoder.

The encoder and/or decoder of the embodiments can be provided in a user equipment or terminal.

FIG. 5 is a schematic block diagram of a user equipment or media terminal 80 housing a decoder 60 with a filtering control device 100 (intra prediction control device). The user equipment 80 can be any device having media decoding functions that operates on an encoded video stream of encoded video frames to thereby decode the video frames and make the video data available. Non-limiting examples of such devices include mobile telephones and other portable media players, tablets, desktops, notebooks, personal video recorders, multimedia players, video streaming servers, set-top boxes, TVs, computers, decoders, game consoles, etc. The user equipment 80 comprises a memory 84 configured to store encoded video pictures or frames. These encoded video frames can have been generated by the user equipment 80 itself. Alternatively, the encoded video frames are generated by some other device and wirelessly transmitted or transmitted by wire to the user equipment 80. The user equipment 80 then comprises a transceiver (transmitter and receiver) or input and output port 82 to achieve the data transfer.

The encoded video frames are brought from the memory 84 to a decoder 60, such as the decoder illustrated in FIG. 3. The decoder 60 comprises a filtering control device 100 (intra prediction control device) according to embodiments. The decoder 60 then decodes the encoded video frames into decoded video frames. The decoded video frames are provided to a media player 86 that is configured to render the decoded video frames into video data that is displayable on a display or screen 88 of or connected to the user equipment 80.

In FIG. 5, the user equipment 80 has been illustrated as comprising both the decoder 60 and the media player 86, with the decoder 60 implemented as a part of the media player 86. This should, however, merely be seen as an illustrative but non-limiting example of an implementation embodiment for the user equipment 80. Also distributed implementations are possible where the decoder 60 and the media player 86 are provided in two physically separated devices are possible and within the scope of user equipment 80 as used herein. The display 88 could also be provided as a separate device connected to the user equipment 80, where the actual data processing is taking place.

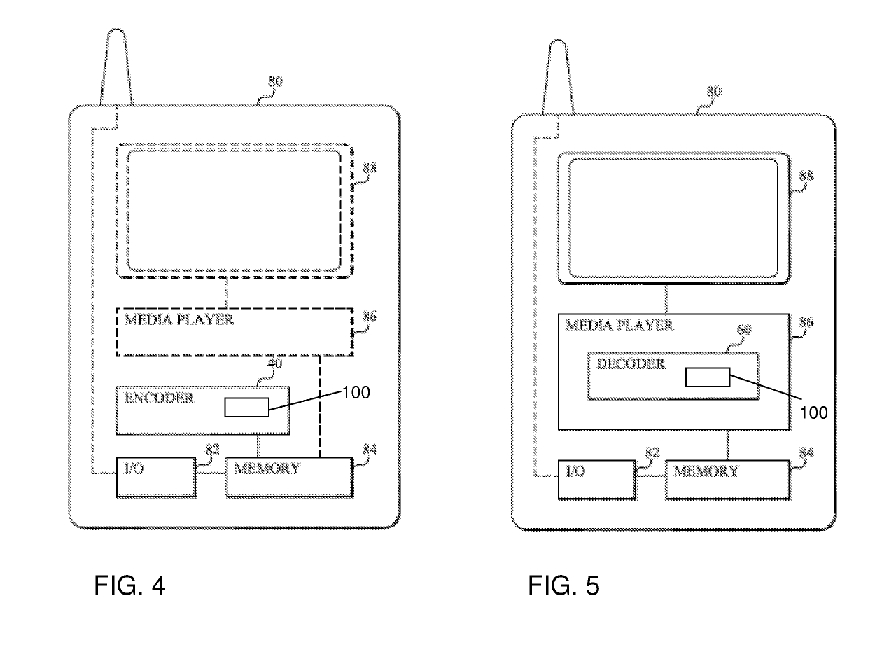

FIG. 4 illustrates another embodiment of a user equipment 80 that comprises en encoder 40, such as the encoder of FIG. 2, comprising a filtering control device 100 (intra prediction control device) according to the embodiments. The encoder 40 is then configured to encode video frames received by the I/O unit 82 and/or generated by the user equipment 80 itself. In the latter case, the user equipment 80 preferably comprises a media engine or recorder, such as in the form of or connected to a (video) camera. The user equipment 80 may optionally also comprise a media player 86, such as a media player 86 with a decoder and filtering control device (intra prediction control device) according to the embodiments, and a display 88.

A particular embodiments relates to a media terminal comprising a processing unit and a memory. The memory comprises code means executable by the processing unit. The media terminal is operative to check a block size of an intra-predicted block of pixels of a picture in a video sequence. The media terminal is also operative to compare the block size to a specified threshold and determine whether to apply filtering of top-most and/or left-most pixels in the intra-predicted block of pixels based on the comparison of the block size to the specified threshold.

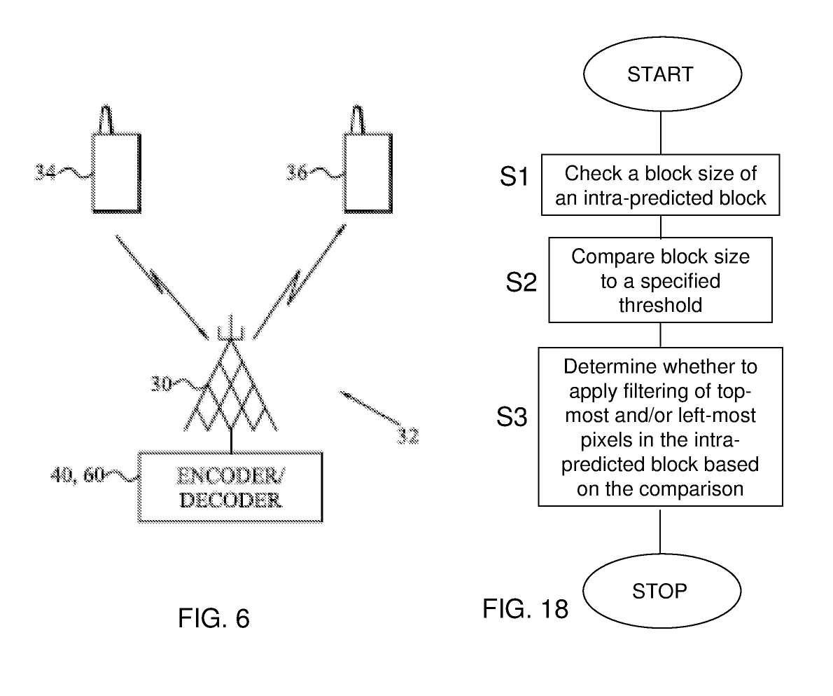

As illustrated in FIG. 6, the encoder 40 and/or decoder 60, such as illustrated in FIGS. 2 and 3, may be implemented in a network device 30 being or belonging to a network node in a communication network 32 between a sending unit 34 and a receiving user equipment 36. Such a network device 30 may be a device for converting video according to one video coding standard to another video coding standard, for example, if it has been established that the receiving user equipment 36 is only capable of or prefers another video coding standard than the one sent from the sending unit 34. The network device can be in the form of or comprised in a radio base station, a Node-B or any other network node in a communication network 32, such as a radio-based network.

The embodiments are not limited to HEVC but may be applied to any extension of HEVC such as a scalable extension or multiview extension or to a different video codec.

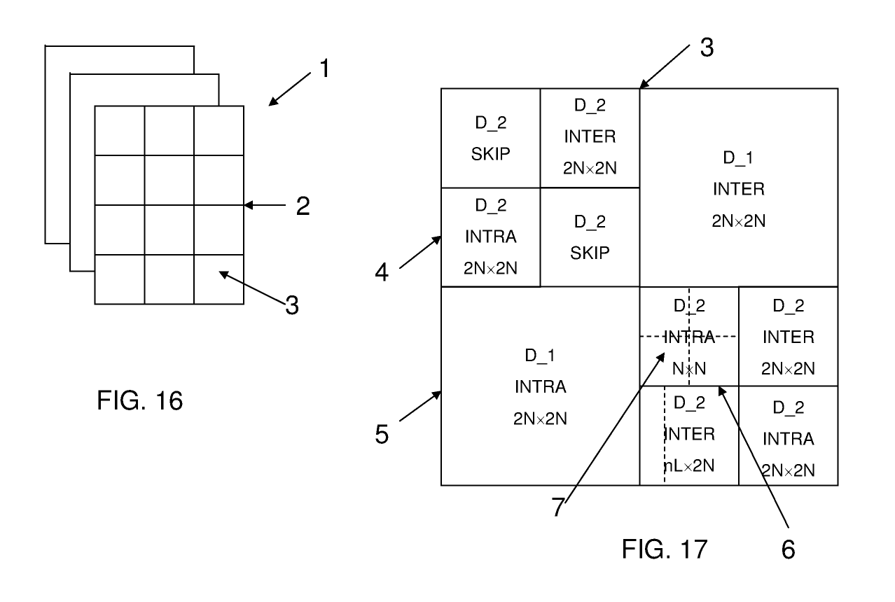

A video sequence 1 of pictures 2, see FIG. 16, encoded and decoded according to the HEVC video coding standard, also denoted MPEG-H Part 2 and H.265 in the art, is generally partitioned into so called coding tree units (CTUs) 3. Such a CTU 3 covers a certain area of the picture, typically 64×64 pixels, although other CTU sizes are possible.

A picture 2 could be decomposed into luma coding tree blocks (CTBs) and chroma CTBs. Thus, a given area of the picture 2 constitutes a luma CTB if the pixels have a respective luma value. Two corresponding chroma CTBs occupy the same area of the picture 2 and have pixels with respective chroma values. A CTU then comprises such a luma CTB and the corresponding two chroma CTBs.

In HEVC, a CTU 3 comprises one or more so-called coding units (CUs) of pixels and a luma/chroma CTB correspondingly comprises one or more so-called luma/chroma coding blocks (CBs) of pixels.

In a particular embodiment, a CTU (CTB) 3 is partitioned into one or more CUs (CBs) 4, 5, 6 to form a quad-tree structure as shown in FIG. 17. Hence, each CTU 3 in a picture can be split recursively in a quad-split manner, e.g. a CTU 3 of 64×64 pixels can be split into four CUs 5 of 32×32 pixels, each of which can be split into four CUs 4, 6 of 16×16 pixels, each of which can be further split into four CUs of 8×8 pixels. This recursively splitting of a CTU can take place in a number of steps or depths from a largest coding unit (LCU) size, i.e. CTU, such as 64×64 pixels, generally having depth 0, down to a smallest coding unit (SCU) size, such as 8×8 pixels. In FIG. 17 the depth values have been indicated by D_1 and D_2.

Each CU 4, 5, 6 have a prediction mode selected from intra prediction (intra), inter prediction (inter) and skipped mode (skip). Intra prediction uses pixel information available in the current picture as prediction reference, and a prediction direction is signaled as coding parameter for each prediction unit (PU). Inter prediction uses pixel information available in the past or future pictures as prediction reference, and for that purpose motion vectors are sent as coding parameters for the PUs to signal the motion relative to the prediction reference. A skipped CU is similar to an inter-predicted CU. However, no motion information is sent. Hence, a skipped CU reuses motion information already available from previous or future pictures.

A CU 6 may additionally be split into one or more PUs 7. For intra-predicted CUs 4, 5, 6 there are two available partitioning modes defining the partition of the CU 4, 5, 6 into PU(s). In the 2N×2N mode the size of the PU in terms of the number of pixels is equal to the size of the CU 4, 5. Hence, no further splitting of the CU into multiple PUs is done. In the other partitioning mode for intra-predicted CUs, N×N, a CU 6 is split into four equally sized PUs 7. Each PU of an intra-predicted CU has a respective intra prediction mode, such as one of the 33 possible intra prediction directions, DC prediction mode or planar prediction mode.

Inter-predicted CUs have several available partitioning modes defining whether the inter-predicted CU comprises one, two or four PUs. Each PU of an inter-predicted CU has a corresponding motion vector or vectors that point(s) to a respective prediction reference of a past or a future picture.

In correspondences to the relation between CTU consisting of one luma CTB and two chroma CTBs, a CU consists of one luma coding block (CB) and two chroma CBs and a PU consists of one luma prediction block (PB) and two chroma PBs.

An intra-predicted block of pixels could, when applied to HEVC, be represented as an intra PU 4, 5, 7 within a CTU 3 of a picture. Alternatively, the intra-predicted block of pixels could, when applied to HEVC, be represented as an intra PB within a CTB of a picture and then in particular an intra luma PB within a luma CTB of a picture.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A filtering control method comprising:
checking (S1, S1′) a block size of an intra-predicted block (4, 5, 7) of pixels of a picture (2) in a video sequence (1);
comparing (S2, S2′) said block size to a specified threshold; and
determining (S3, S3′) whether to apply filtering of top-most and/or left-most pixels in said intra-predicted block of pixels based on said comparison of said block size to said specified threshold.

2. The filtering control method according to claim 1, further comprising applying (S4) filtering of said top-most and/or said left-most pixels in said intra-predicted block (4, 5, 7) of pixels if said block size is smaller than said specified threshold.

3. The filtering control method according to claim 1 or 2, further comprising preventing (S5) applying filtering of said top-most and/or said left-most pixels in said intra-predicted block (4, 5, 7) of pixels if said block size is not smaller than said specified threshold.

4. The filtering control method according to any of the claims 1 to 3, further comprising:
determining (S30) that said intra-predicted block (4, 5, 7) of pixels is intra-predicted according to a DC prediction mode, wherein determining (S3) whether to apply filtering comprises determining (S32) whether to apply filtering of said top-most and said left-most pixels in said intra-predicted block (4, 5, 7) of pixels based on said comparison of said block size to said specified threshold.

5. The filtering control method according to claim 4, further comprising:
calculating (S31) a variable
$$DCVal = ( {\sum }_{{x}^{′} = 0}^{nS - 1} p [ {x}^{′} , - 1 ] + {\sum }_{{y}^{′} = 0}^{nS - 1} p [ - 1 , {y}^{′} ] + nS ) >> ( k + 1 ) ,$$
wherein p[x,y] denotes a pixel value of a pixel at position x,y=0 . . . nS−1 within said intra-predicted block (4, 5, 7) of pixels, k=log 2(nS), nS represents a width and height of said intra-predicted block (4, 5, 7) of pixels and >> represents a right shift operator defined as
$$a >> b = ⌊ \frac{a}{{2}^{b}} ⌋$$
and └c┘ is a largest integer not greater than c, wherein determining (S3) whether to apply filtering comprises determining (S33), if cIdx=0 and nS<32, predicted sample values, predSamples[x], of said pixels in said intra-predicted block (4, 5, 7) of pixels to be:
predSamples[0,0]=(1×p[−1,0]+2×DCVal+1×p[0,−1]+2)>>2
predSamples[x,0]=(1×p[x,−1]+3×DCVal+2)>>2, with x=1 . . . nS−1
predSamples[0,y]=(1×p[−1,y]+3DCVal+2)>>2, with y=1 . . . nS−1
predSamples[x,y]=DCVal, with x,y=1 . . . nS−1
and otherwise determining (S34) said predicted sample values to be:
predSamples[x,y]=DCVal, with x,y=0 . . . nS−1,
wherein cIdx represents a chroma component index and cIdx=0 indicates that said pixel values of said pixels are luma components.

6. The filtering control method according to any of the claims 1 to 3, further comprising:
determining (S40) that said intra-predicted block (4, 5, 7) of pixels is intra-predicted according to a vertical prediction mode, wherein determining (S3) whether to apply filtering comprises determining (S41) whether to apply filtering of said left-most pixels in said intra-predicted block (4, 5, 7) of pixels based on said comparison of said block size to said specified threshold.

7. The filtering control method according to claim 6, wherein determining (S3) whether to apply filtering comprises determining (S42), if cIdx=0 and nS<32, predicted sample values, predSamples[x,y], of said pixels in said intra-predicted block (4, 5, 7) of pixels to be:
predSamples[0,y]=Clip1_{Y}(p[0,−1]+(p[−1,y]−p[−1,−1])>>1), with y=0 . . . nS−1
predSamples[x,y]=p[x,−1], with x=1 . . . nS−1, y=0 . . . nS−1
and otherwise determining (S42) said predicted sample values to be:
predSamples[x,y]=p[x,−1], with x,y=0 . . . nS−1,
wherein p[x,y] denotes a pixel value of a pixel at position x,y=0 . . . nS−1 within said intra-predicted block (4, 5, 7) of pixels, nS represents a width and height of said intra-predicted block (4, 5, 7) of pixels, cIdx represents a chroma component index and cIdx=0 indicates that said pixel values of said pixels are luma components, >> represents a right shift operator defined as
$$a >> b = ⌊ \frac{a}{{2}^{b}} ⌋$$
and └c┘ is a largest integer not greater than c, Clip1_{Y}(d)=Clip3(0,(1<<BitDepth_{Y})−1, d), BitDepth_{Y} denotes bit depth of said luma components, << represents a left shift operator defined as
$$a << b = a \times {2}^{b} and Clip 3 ( e , f , g ) = \{ \begin{matrix}e , & if g < e \\ f , & if g > f \\ g , & otherwise\end{matrix} \} .$$

8. The filtering control method according to any of the claims 1 to 3, further comprising:
determining (S50) that said intra-predicted block (4, 5, 7) of pixels is intra-predicted according to a horizontal prediction mode, wherein determining (S3) whether to apply filtering comprises determining (S51) whether to apply filtering of said top-most pixels in said intra-predicted block (4, 5, 7) of pixels based on said comparison of said block size to said specified threshold.

9. The filtering control method according to claim 8, wherein determining (S3) whether to apply filtering comprises determining (S52), if cIdx=0 and nS<32, predicted sample values, predSamples[x,y], of said pixels in said intra-predicted block (4, 5, 7) of pixels to be:
predSamples[x,0]=Clip1_{Y}(p[−1,0]+(p[x,−1]−p[−1,−1])>>1), with x=0 . . . nS−1
predSamples[x,y]=p[−1,y], with x=0 . . . nS−1, y=1 . . . nS−1
and otherwise determining (S53) said predicted sample values to be:
predSamples[x,y]=p[−1,y], with x,y=0 . . . nS−1
wherein p[x,y] denotes a pixel value of a pixel at position x,y=0 . . . nS−1 within said intra-predicted block (4, 5, 7) of pixels, nS represents a width and height of said intra-predicted block (4, 5, 7) of pixels, cIdx represents a chroma component index and cIdx=0 indicates that said pixel values of said pixels are luma components, >> represents a right shift operator defined as
$$a >> b = ⌊ \frac{a}{{2}^{b}} ⌋$$
and └c┘ is a largest integer not greater than c, Clip1_{Y}(d)=Clip3(0,(1<<BitDepth_{Y})−1,d), BitDepth_{Y} denotes bit depth of said luma components, << represents a left shift operator defined as
$$a << b = a \times {2}^{b} and Clip 3 ( e , f , g ) = \{ \begin{matrix}e , & if g < e \\ f , & if g > f \\ g , & otherwise\end{matrix} \} .$$

10. A filtering control device (100) comprising:
a processing unit (120) configured to i) check a block size of an intra-predicted block (4, 5, 7) of pixels of a picture (2) in a video sequence (1) and ii) compare said block size to a specified threshold; and
a determining unit (110) configured to determine whether to apply filtering of top-most and/or left-most pixels in said intra-predicted block (4, 5, 7) of pixels based on said comparison of said block size to said specified threshold.

11. The filtering control device according to claim 10, wherein said processing unit (120) is configured to apply filtering of said top-most and/or said left-most pixels in said intra-predicted block (4, 5, 7) of pixels if said block size is smaller than said specified threshold.

12. The filtering control device according to claim 10 or 11, wherein said processing unit (120) is configured to prevent applying filtering of said top-most and/or said left-most pixels in said intra-predicted block (4, 5, 7) of pixels if said block size is not smaller than said specified threshold.

13. The filtering control device according to any of the claims 10 to 12, wherein said determining unit (110) is configured to determine, for luma components of said pixels, whether to apply filtering of top-most and/or left-most pixels in said intra-predicted block (4, 5, 7) of pixels based on said comparison of said block size to said specified threshold.

14. The filtering control device according to any of the claims 10 to 13, wherein said determining unit (110) is configured to determine that said intra-predicted block (4, 5, 7) of pixels is intra-predicted according to a DC prediction mode, and determine whether to apply filtering of said top-most and said left-most pixels in said intra-predicted block (4, 5, 7) of pixels based on said comparison of said block size to said specified threshold.

15. The filtering control device according to claim 14, wherein
said processing unit (120) is configured to calculate a variable
$$DCVal = ( {\sum }_{{x}^{′} = 0}^{nS - 1} p [ {x}^{′} , - 1 ] + {\sum }_{{y}^{′} = 0}^{nS - 1} p [ - 1 , {y}^{′} ] + nS ) >> ( k + 1 ) ,$$
wherein p[x,y] denotes a pixel value of a pixel at position x,y=0 . . . nS−1 within said intra-predicted block (4, 5, 7) of pixels, k=log 2(nS), nS represents a width and height of said intra-predicted block (4, 5, 7) of pixels and >> represents a right shift operator defined as
$$a >> b = ⌊ \frac{a}{{2}^{b}} ⌋$$
and └c┘ is a largest integer not greater than c, and
said determining unit (110) is configured to determine, if cIdx=0 and nS<32, predicted sample values, predSamples[x,y], of said pixels in said intra-predicted block (4, 5, 7) of pixels to be:
predSamples[0,0]=(1×p[−1,0]+2×DCVal+1×p[0,−1]+2)>>2
predSamples[x,0]=(1×p[x,−1]+3×DCVal+2)>>2, with x=1 . . . nS−1
predSamples[0,y]=(1×p[−1,y]+3DCVal+2)>>2, with y=1 . . . nS−1
predSamples[x,y]=DCVal, with x,y=1 . . . nS−1
and otherwise determine said predicted sample values to be:
predSamples[x,y]=DCVal, with x,y=0 . . . nS−1,
wherein cIdx represents a chroma component index and cIdx=0 indicates that said pixel values of said pixels are luma components.

16. The filtering control device according to any of the claims 10 to 13, wherein said determining unit (110) is configured to determine that said intra-predicted block (4, 5, 7) of pixels is intra-predicted according to a vertical prediction mode, and determine whether to apply filtering of said left-most pixels in said intra-predicted block (4, 5, 7) of pixels based on said comparison of said block size to said specified threshold.

17. The filtering control device according to claim 16, wherein said determining unit (110) is configured to determine, if cIdx=0 and nS<32, predicted sample values, predSamples[x,y], of said pixels in said intra-predicted block (4, 5, 7) of pixels to be:
predSamples[0,y]=Clip1_{Y}(p[0,−1]+(p[−1,y]−p[−1,−1])>>1), with y=0 . . . nS−1
predSamples[x,y]=p[x,−1], with x=1 . . . nS−1, y=0 . . . nS−1
and otherwise determine said predicted sample values to be:
predSamples[x,y]=p[x,−1], with x,y=0 . . . nS−1,
wherein p[x,y] denotes a pixel value of a pixel at position x,y=0 . . . nS−1 within said intra-predicted block (4, 5, 7) of pixels, nS represents a width and height of said intra-predicted block (4, 5, 7) of pixels, cIdx represents a chroma component index and cIdx=0 indicates that said pixel values of said pixels are luma components, >> represents a right shift operator defined as
$$a >> b = ⌊ \frac{a}{{2}^{b}} ⌋$$
and └c┘ is a largest integer not greater than c, Clip1_{Y}(d)=Clip3(0,(1<<BitDepth_{Y})−1,d), BitDepth_{Y} denotes bit depth of said luma components, << represents a left shift operator defined as
$$a << b = a \times {2}^{b} and Clip 3 ( e , f , g ) = \{ \begin{matrix}e , & if g < e \\ f , & if g > f \\ g , & otherwise\end{matrix} \} .$$

18. The filtering control device according to any of the claims 10 to 13, wherein said determining unit (110) is configured to determine that said intra-predicted block (4, 5, 7) of pixels is intra-predicted according to a horizontal prediction mode, and determine whether to apply filtering of said top-most pixels in said intra-predicted block (4, 5, 7) of pixels based on said comparison of said block size to said specified threshold.

19. The filtering control device according to claim 18, wherein said determining unit (110) is configured to determine, if cIdx=0 and nS<32, predicted sample values, predSamples[x,y], of said pixels in said intra-predicted block (4, 5, 7) of pixels to be:
predSamples[x,0]=Clip1_{Y}(p[−1,0]+(p[x,−1]−p[−1,−1])>>1), with x=0 . . . nS−1
predSamples[x,y]=p[−1,y], with x=0 . . . nS−1, y=1 . . . nS−1
and otherwise determine said predicted sample values to be:
predSamples[x,y]=p[−1,y], with x,y=0 . . . nS−1
wherein p[x,y] denotes a pixel value of a pixel at position x,y=0 . . . nS−1 within said intra-predicted block (4, 5, 7) of pixels, nS represents a width and height of said intra-predicted block (4, 5, 7) of pixels, cIdx represents a chroma component index and cIdx=0 indicates that said pixel values of said pixels are luma components, >> represents a right shift operator defined as
$$a << b = a \times {2}^{b} and Clip 3 ( e , f , g ) = \{ \begin{matrix}e , & if g < e \\ f , & if g > f \\ g , & otherwise\end{matrix} \} .$$
and └c┘ is a largest integer not greater than c, Clip1_{Y}(d)=Clip3(0,(1<<BitDepth_{Y})−1, d), BitDepth_{Y} denotes bit depth of said luma components, << represents a left shift operator defined as
$$a >> b = ⌊ \frac{a}{{2}^{b}} ⌋$$

20. An encoder (40) comprising a filtering control device (100) according to any of the claims 10 to 19.

21. A decoder (60) comprising a filtering control device (100) according to any of the claims 10 to 19.

22. A user equipment (80) comprising an encoder (40) according to claim 20 and/or a decoder (60) according to claim 21.

23. A network device (30) being or belonging to a network node in a communication network (32), said network device (30) comprising an encoder (40) according to claim 20 and/or a decoder (60) according to claim 21.

24. A computer program (74) for filtering control, said computer program (74) comprises code means which when executed by a processing unit (72) causes said compressing unit (72) to:
check a block size of an intra-predicted block (4, 5, 7) of pixels of a picture (2) in a video sequence (1);
compare said block size to a specified threshold; and
determine whether to apply filtering of top-most and/or left-most pixels in said intra-predicted block (4, 5, 7) of pixels based on said comparison of said block size to said specified threshold.

25. A computer program product (73) comprising computer readable code means and a computer program (74) according to claim 24 stored on said computer readable code means.

26. A media terminal (70, 80, 90) comprising:
a processing unit (72); and
a memory (73) comprising code means executable by said processing unit (72), whereby said media terminal (70, 80, 90) is operative to:
check a block size of an intra-predicted block (4, 5, 7) of pixels of a picture (2) in a video sequence (1);
compare said block size to a specified threshold; and
determine whether to apply filtering of top-most and/or left-most pixels in said intra-predicted block of pixels based on said comparison of said block size to said specified threshold.
